(19) United States
(12) Patent Application Publication
(10) Pub. No.: US 2026/0195865 A1
(43) Pub. Date: Jul. 9, 2026

(54) PIXELWISE NOISE QUANTIFICATION IN COMPUTED TOMOGRAPHY IMAGES USING A DEEP LEARNING MODEL

(71) Applicant: Mayo Foundation for Medical Education and Research, Rochester, MN (US)

(72) Inventors: Nathan R. Huber, Rochester, MN (US); Lifeng Yu, Byron, MN (US); Shuai Leng, Rochester, MN (US); Cynthia H. McCollough, Byron, MN (US)

(21) Appl. No.: 19/132,989

(22) PCT Filed: Nov. 27, 2023
(86) PCT No.: PCT/US2023/081214

§ 371 Date: May 27, 2025

Related U.S. Application Data
(60) Provisional application No. 63/384,994, filed on Nov. 25, 2022.

(51) Int. Cl. G06T 5/60; G06T 5/70; G06T 7/00

(52) U.S. Cl. CPC G06T 5/60; G06T 5/70; G06T 7/0012; G06T 2207/10081; G06T 2207/20081; G06T 2207/20084; G06T 2207/20224; G06T 2207/30168

(57) ABSTRACT

Image quality can be assessed in a patient-specific manner using deep learning. Deep learning is used to extract image quality metrics (e.g. noise metrics, resolution metrics, noise correlation metrics) directly from image-based features, thereby enabling patient-specific image quality assessment. A neural network, or other suitable machine learning algorithm, is trained and implemented to generate noise maps from patient CT data, where the noise maps quantify the pixelwise noise level in the patient CT data.

### CROSS-REFERENCE TO RELATED APPLICATIONS

This application claims the benefit of U.S. Provisional Patent Application Ser. No. 63/384,994, filed on Nov. 25, 2022, and entitled “PIXELWISE NOISE QUANTIFICATION IN COMPUTED TOMOGRAPHY IMAGES USING A DEEP LEARNING MODEL,” which is herein incorporated by reference in its entirety.

### BACKGROUND

Computed tomography (“CT”) is a medical imaging modality that uses x-ray radiation to obtain a three-dimensional representation of human anatomy. CT image quality assessment is performed routinely for equipment evaluation and scanning protocol optimization. One important indicator of image quality is image noise. Noise is typically measured using standardized image quality phantoms; however, phantom-based measurement is not ideal because it does not reflect how the system operates on patients in standard practice. Noise measurement techniques within patient exams are limited, most commonly noise in patient exams is manually measured as the standard deviation of CT numbers within a uniform region-of-interest (“ROI”). Ideally, there would be fully automatic tools for measuring pixelwise noise level in patient CT images. The difficulty of reliable noise quantification in patient images is a barrier for protocol optimization and image quality standardization across patients and practices.

Some methods have been proposed for global and pixelwise measurement of image noise in patient CT images. Global metrics aim to distill noise level within a patient exam into a single quantity. In one example method, a global noise index that automatically determines uniform regions of patient anatomy was used, after which standard deviation measurements in these regions were applied and the most frequent noise level measured was reported. Global noise assessment has also been achieved with deep learning-based methods. For example, in one example method a CNN was trained to predict radiologist assigned labels of subjective image quality ratings for patient CT images.

In contrast, pixelwise noise quantification aims to quantify the spatial variations in noise level within individual patient images. For simple geometries, pixelwise noise characteristics can be analytically determined by propagating a noise model through the reconstruction process. To mimic a clinical scenario, CT simulation tools and projection noise insertion can be used to approximate pixelwise CT patient noise. However, previous techniques for pixelwise noise quantification have not been adopted due to inaccessibility of clinical CT projection data, lack of manufacturer transparency about the data pre-processing and image reconstruction process, extensive computational processing times, or inaccuracy of the results.

### SUMMARY OF THE DISCLOSURE

The present disclosure addresses the aforementioned drawbacks by providing a method for quantifying pixelwise noise level in computed tomography (“CT”) images of a subject. The method includes accessing, with a computer system, a CT image acquired from a subject using a CT imaging system. A neural network that has been trained on CT images and corresponding noise maps to quantify pixelwise noise levels in input CT image data is also accessed with the computer system. A noise map is then generated by inputting the CT image to the neural network using the computer system, thereby generating an output as the noise map, which quantifies a pixelwise noise level in the CT image. The noise map is then stored or displayed to a user.

It is another aspect of the present disclosure to provide a method for quantifying pixelwise image quality in CT images of a subject. The method includes accessing, with a computer system, a CT image acquired from a subject using a CT imaging system. A neural network is also accessed with the computer system, where the neural network has been trained on CT images and corresponding image quality metric maps to quantify pixelwise image quality levels in input CT image data. An image quality metric map is generated by inputting the CT image to the neural network using the computer system, generating an output as the image quality metric map, where the image quality metric map quantifies a pixelwise image quality level in the CT image. The image quality metric map may then be displayed to a user by the computer system, or stored using the computer system.

It is still another aspect of the present disclosure to provide a method for quantifying pixelwise image quality in CT images of a subject. The method includes accessing, with a computer system, a CT image acquired from a subject using a CT imaging system. A neural network is also accessed with the computer system, where the neural network has been trained on CT images and corresponding image quality metric maps to quantify pixelwise image quality levels in input CT image data. An image quality metric map is generated by inputting the CT image to the neural network using the computer system, generating an output as the image quality metric map, where the image quality metric map quantifies a pixelwise image quality level in the CT image. In some non-limiting examples, the image quality metric map is one of a resolution map that quantifies a pixelwise image resolution level in the CT image or a noise correlation map that quantifies a pixelwise noise correlation level in the CT image. The image quality metric map may then be displayed to a user by the computer system, or stored using the computer system.

It is yet another aspect of the present disclosure to provide a method for generating a denoised CT image of a subject. The method includes accessing, with a computer system, a CT image acquired from a subject using a CT imaging system. A neural network is also accessed with the computer system, where the neural network has been trained on CT images and corresponding noise maps to quantify pixelwise noise levels in input CT image data. A noise map is generated by inputting the CT image to the neural network using the computer system, generating an output as the noise map, where the noise map quantifies local noise levels in the CT image. The CT image is then denoised with the computer system by: accessing a denoising neural network that has been trained to denoise CT images; generating an updated denoising neural network by adjusting denoising weights in the denoising neural network based on the local noise levels of the CT image quantified in the noise map; and inputting the CT image to the updated denoising neural network, generating an output as a denoised CT image. The denoised CT image may then be displayed to a user by the computer system, or stored using the computer system.

It is another aspect of the present disclosure to provide a method for training a neural network to quantify pixelwise noise levels in input CT image data. The method includes accessing training data with a computer system, wherein the training data include data pairs that include a CT image paired with a noise map generated from the CT image. Augmented training data are generated with the computer system by applying a random linear scaling of image noise to each CT image in the training data. The neural network is then trained on the augmented training data using the computer system, generating an output as a pretrained neural network. The pretrained neural network is then stored with the computer system.

The foregoing and other aspects and advantages of the present disclosure will appear from the following description. In the description, reference is made to the accompanying drawings that form a part hereof, and in which there is shown by way of illustration one or more embodiments. These embodiments do not necessarily represent the full scope of the invention, however, and reference is therefore made to the claims and herein for interpreting the scope of the invention.

### BRIEF DESCRIPTION OF THE DRAWINGS

FIG. 1 is a flowchart of an example method for generating a noise map from a patient CT image, where the noise map quantifies the pixelwise noise level in the patient CT image.

FIG. 2 is a flowchart of an example method for training a neural network, or other machine learning algorithm, to quantify pixelwise noise levels in CT image data.

FIGS. 3A-3D show a schematic of a SILVER framework. FIG. 3A shows chest, pelvis, and head anthropomorphic phantoms, which were scanned with 100 repeated acquisitions in an example study to form training data. FIG. 3B shows calculated noise maps generated as the pixelwise standard deviation of phantom images. Phantom scans (input) and calculated noise maps (labels) were split into training patches. FIG. 3C shows a convolutional neural network (CNN) resembling U-Net that was trained to predict a pixel noise map directly from a single CT image. FIG. 3D shows a schematic of an example workflow for training and implementing a SILVER model. First, a phantom was scanned with 100 repeated sequential acquisitions. Pixelwise standard deviation was calculated to generate noise maps. Phantom scans (input) and corresponding noise maps (labels) were split into training patches (64×64 pixels). The SILVER model was trained to predict noise map based on CT image. Following training, the SILVER model was applied to patient CT exams.

FIGS. 4A and 4B show SILVER predicted noise maps for pelvis and chest phantom for (FIG. 4A) smooth (B30) and (FIG. 4B) medium-sharp kernel (D45) images. The first column is the phantom test CT image (WL: 50, WW: 400), second column is SILVER noise map prediction, third column is the calculated noise map based on 100 repeated phantom scans, fourth column is the difference of SILVER prediction and calculated noise map, and fifth column is the percent error of SILVER prediction relative to calculated noise map.

FIG. 5 shows repeatability noise measurements within a uniform cylindrical phantom. The variability in the noise measurement plotted as a function of ROI radius. The SILVER noise map had much less variability than the ROI SD measurements below 20-pixel radius. ROI: region of interest, SD: standard deviation.

FIG. 6 shows representative patient CT images and corresponding SILVER noise map prediction, at two dose levels (RD: routine dose, QD: quarter dose) and two kernels (B30: smooth, D45: medium sharp). Notice the large variety in noise levels and textures observed within the patient dataset.

FIG. 7 is a block diagram of an example deep learning-based pixelwise noise quantification system.

FIG. 8 is a block diagram of example components that can implement the system of FIG. 7.

### DETAILED DESCRIPTION

Described here are systems and methods for assessing image quality in a patient-specific manner using deep learning. In general, the systems and methods described in the present disclosure use deep learning to extract image quality metrics (e.g., noise metrics, resolution, noise correlation) directly from image-based features, thereby enabling patient-specific image quality assessment.

Evaluating image quality (e.g., noise, resolution, noise correlation) directly from patient data is advantageous for protocol optimization; however, prior methods for image quality assessment are phantom-based and unable to fully meet this need. The disclosed systems and methods provide a widely accessible deep learning framework in which a neural network predicts image quality metrics (e.g., noise metrics, resolution, noise correlation) directly from patient data. Training data include repeated samplings of anthropomorphic phantom data to extract image quality labels, and transfer learning can be used to apply the trained network to patient exams.

Thus, the disclosed systems and methods provide a deep-learning-based technique to estimate the pixelwise noise level of patient CT images. Additionally or alternatively, the systems and methods can be adapted to estimate other image quality metrics, such as resolution and noise correlation. This technique may be referred to as single-scan image local variance estimator (“SILVER”). Deep learning enables estimation of pixelwise noise level, or other image quality metrics, based on image features within an individual patient exam.

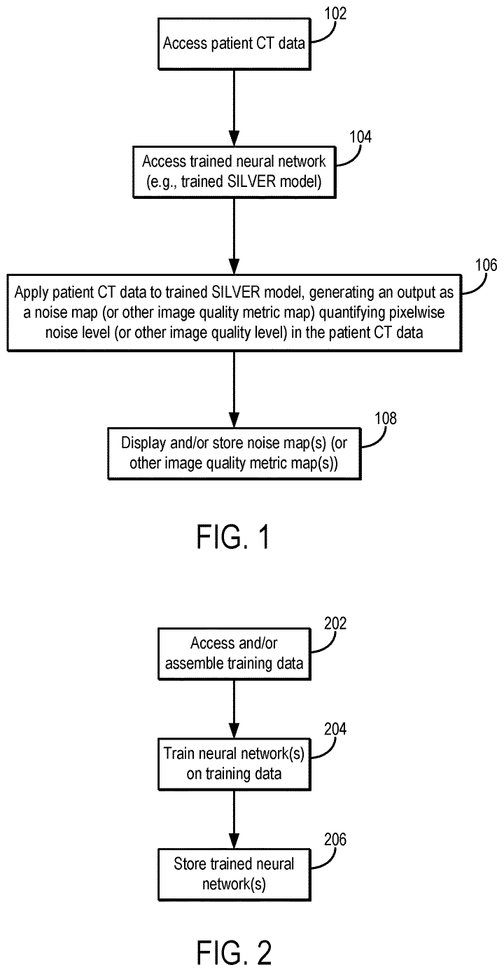

Referring now to FIG. 1, a flowchart is illustrated as setting forth the steps of an example method for quantifying patient-specific, pixelwise noise level, or other image quality metrics, in CT images of a patient using a suitably trained neural network or other machine learning algorithm. As will be described, the neural network or other machine learning algorithm takes patient CT data as input data and generates one or more noise maps, or other image quality metric maps, as output data, where the noise map(s) indicate a quantification of the pixelwise noise level, or other image quality metrics, in the input patient CT data.

The method includes accessing patient CT data with a computer system, as indicated at step 102. Accessing the patient CT data may include retrieving such data from a memory or other suitable data storage device or medium. Additionally or alternatively, accessing the patient CT data may include acquiring such data from a patient using a CT imaging system and transferring or otherwise communicating the data to the computer system, which may be a part of the CT imaging system. The patient CT data may include raw projection data, CT images, or both. When the patient CT data include raw projection data, step 102 may include reconstructing images of the patient from the raw projection data. Images may be reconstructed using standard image reconstruction techniques (e.g., filtered backprojection), and also iterative reconstruction, deep learning-based reconstructions, and the like.

A trained neural network (or other suitable machine learning algorithm) is then accessed with the computer system, as indicated at step 104. In general, the neural network is trained, or has been trained, on training data in order to quantify pixelwise noise level (and/or local noise levels) in images of a patient obtained with a CT imaging system, such as the patient CT data accessed in step 104. Additionally or alternatively, the neural network can be trained to quantify other image quality metrics, such as resolution and/or noise correlation. In some instances, more than one neural network may be accessed, with each neural network having been trained to quantify a different image quality metric. In still other embodiments, a single neural network may be trained to output more than one image quality metric.

Accessing the trained neural network may include accessing network parameters (e.g., weights, biases, or both) that have been optimized or otherwise estimated by training the neural network on training data. In some instances, retrieving the neural network can also include retrieving, constructing, or otherwise accessing the particular neural network architecture to be implemented. For instance, data pertaining to the layers in the neural network architecture (e.g., number of layers, type of layers, ordering of layers, connections between layers, hyperparameters for layers) may be retrieved, selected, constructed, or otherwise accessed.

An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs. In an example in which the artificial neural network is trained to generate a quantitative estimate of the pixelwise noise level and/or local noise levels in a CT image, the output layer may include, for example, a number of different nodes, where each different node corresponds to a different pixel in the output noise map.

The patient CT data are then input to the one or more trained neural networks, generating output as a patient-specific noise map (or other image quality metric map) that indicates a quantification of the noise level (or other image quality level) in the input patient CT data, as indicated at step 106. Additionally or alternatively, the noise map may quantify noise correlation directly from the patient CT data.

The noise map (or other image quality metric map) generated by inputting the patient CT data to the trained neural network(s) can then be displayed to a user, stored for later use or further processing, or both, as indicated at step 108. As one example, the noise map can be used to perform quality assessment on the patient CT data. As another example, the noise map can be used to optimize the scanning protocol for subsequent imaging of the patient. In still other examples, the noise map may be used to denoise the patient CT data, or the like. For instance, denoising the patient CT data may include accessing a neural network (e.g., a denoising neural network) with the computer system, where the denoising neural network has been trained to denoise CT images. The noise map can then be used to adjust the denoising weights in the trained denoising neural network, thereby using the estimated local noise levels to provide optimal denoising results for the patient CT data.

Referring now to FIG. 2, a flowchart is illustrated as setting forth the steps of an example method for training one or more neural networks (or other suitable machine learning algorithms) on training data, such that the one or more neural networks are trained to receive a a CT image as input data in order to generate a noise map as output data, where the noise map is indicative of a quantification of the pixelwise noise level and/or local noise levels in the input CT image.

In general, the neural network(s) can implement any number of different neural network architectures. For instance, the neural network(s) could implement a convolutional neural network, a residual neural network, or the like. Alternatively, the neural network(s) could be replaced with other suitable machine learning or artificial intelligence algorithms, such as those based on supervised learning, unsupervised learning, deep learning, ensemble learning, dimensionality reduction, and so on.

The method includes accessing training data with a computer system, as indicated at step 202. Accessing the training data may include retrieving such data from a memory or other suitable data storage device or medium. Alternatively, accessing the training data may include acquiring such data with a CT imaging system and transferring or otherwise communicating the data to the computer system.

In general, the training data can include CT images acquired from anthropomorphic phantoms, human subjects, or combinations thereof. The method can also include assembling training data from such CT images using the computer system. This step may include assembling the CT images into an appropriate data structure on which the neural network or other machine learning algorithm can be trained. Assembling the training data may include assembling CT images, segmented CT images, image patches extracted from CT images or segmented CT images, as well as other relevant data. For instance, assembling the training data may include generating labeled data and including the labeled data in the training data. Labeled data may include noise maps generated based on a number of repeated CT image scans.

As will be described, in some example implementations the deep learning SILVER model can be trained with anthropomorphic phantom data. Linear noise scaling data augmentation can also be used to improve generalizability to different noise levels. A noise map can be calculated as the pixelwise standard deviation of repeated scans. Phantom data can be split into patches for training. Training input can include a single CT image and the training label can be the corresponding noise map based on a number of repeated scans (e.g., n=100).

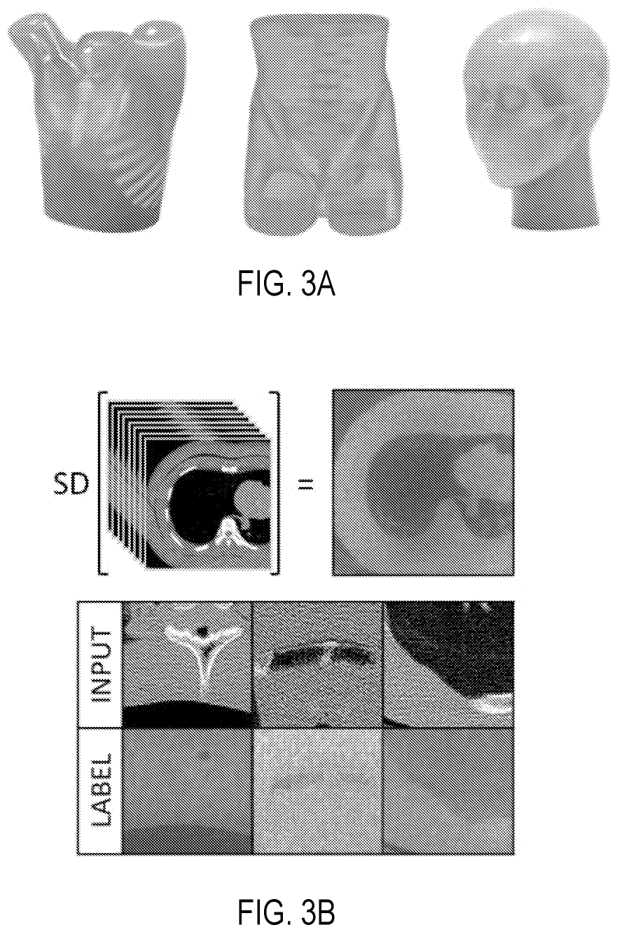

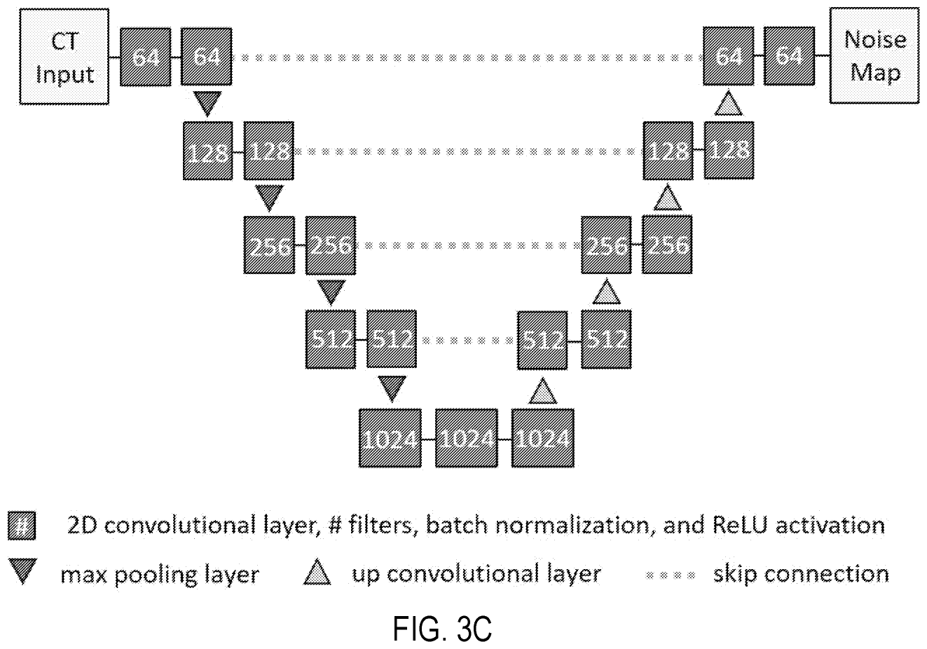

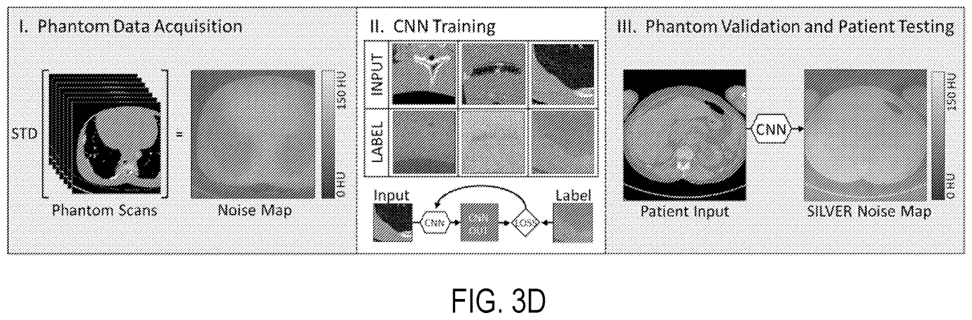

As one non-limiting example, the training data can include CT images of three different anthropomorphic phantoms, which mimic the body habitus of the head (e.g., Angiographic CT Head Phantom ACS, Kyoto Kagaku), chest (e.g., LUNGMAN, Kyoto Kagaku), and pelvis (e.g., RSD Sectional Phantom, 3M), as shown in FIG. 3A. A number of replicate scans of each phantom can be performed. In some embodiments, images of the phantoms may also be augmented, such as by applying translation, rotations, and the like, the images. In one example, 100 replicate scans of each phantom were performed in a sequential scan mode using a dual-source 128-slice scanner at 120 kV with routine dose (200 effective mAs) and quarter dose (50 effective mAs). Automatic tube current and potential systems were turned off in this example. Images were reconstructed using a reconstruction performed with smooth and medium sharp kernels, with an image thickness of 1 mm and a field of view of 420 mm. In this example, a total of 120,000 CT images of the phantoms were acquired, which were allocated into training, validation, and testing datasets (e.g., with an 80:10:10 ratio).

In some embodiments, training patches can be extracted from the CT images in the training data set. For example, 100,000 training patches (64×64 pixels) were extracted from the phantom images described above and used as input (phantom CT image with noise scaling) and target (corresponding pixel noise map). To improve diversity in the training dataset, a random linear scaling of image noise (ranging from 0 to 200%) can be applied to each patch. Linear noise scaling can be applied by subtracting an individual phantom CT image by the n-repetition average (e.g., n=100 in the example above), multiplying the noise-only difference image by a random scaling factor, and then adding the scaled noise-only difference image back into the n-repetition average (Eqn. (1)). A pixel noise map label can be calculated as the pixelwise standard deviation of each set of n-repeated phantom images while accounting for the linear noise scaling term (Eqn. (2)),

Training input with noise scaling:

$$f ( {x}_{i , j} , α ) = {\overline{x}}_{i , j} + α ( {x}_{i , j} - {\overline{x}}_{i , j} ) ; \qquad ( 1 )$$

$$Training target :$$

$$SD ( f ( {x}_{i , j} , α ) ) = \sqrt{\frac{\sum {( f ( {x}_{i , j} , α ) - {\overline{x}}_{i , j} )}^{2}}{n - 1}} = α \sqrt{\frac{\sum {( {x}_{i , j} - {\overline{x}}_{i , j} )}^{2}}{n - 1}} ; \qquad ( 2 )$$

where x_{i,j} is the CT number of the pixel at location (i, j) of the image, x̅_{i,j} is the pixel average from repeated phantom scans, α is a random noise scaling factor (e.g., with value ranging between 0% and 200%), and n is the number of repeat phantom scans (e.g., n=100).

One or more neural networks (or other suitable machine learning algorithms) are trained on the training data, as indicated at step 204. In general, the neural network can be trained by optimizing network parameters (e.g., weights, biases, or both) based on minimizing a loss function. As one non-limiting example, the loss function may be a mean squared error loss function.

Training a neural network may include initializing the neural network, such as by computing, estimating, or otherwise selecting initial network parameters (e.g., weights, biases, or both). During training, an artificial neural network receives the inputs for a training example and generates an output using the bias for each node, and the connections between each node and the corresponding weights. For instance, training data can be input to the initialized neural network, generating output as noise map(s) and/or noise map patches. The artificial neural network then compares the generated output with the actual output of the training example in order to evaluate the quality of the noise map(s) and/or noise map patches. For instance, the noise map(s) and/or noise map patches can be passed to a loss function to compute an error. The current neural network can then be updated based on the calculated error (e.g., using backpropagation methods based on the calculated error). For instance, the current neural network can be updated by updating the network parameters (e.g., weights, biases, or both) in order to minimize the loss according to the loss function. The training continues until a training condition is met. The training condition may correspond to, for example, a predetermined number of training examples being used, a minimum accuracy threshold being reached during training and validation, a predetermined number of validation iterations being completed, and the like. When the training condition has been met (e.g., by determining whether an error threshold or other stopping criterion has been satisfied), the current neural network and its associated network parameters represent the trained neural network. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as supervised learning, unsupervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the artificial neural network is configured to learn a general rule or model that maps the inputs to the outputs based on the provided example input-output pairs.

In one non-limiting example, a convolutional neural network (“CNN”) can be trained via supervised learning to map phantom CT images (with noise scaling) to a corresponding calculated pixel noise map. For instance, the noise maps (labeled data in each data pair) were generated as the pixelwise standard deviation of phantom images (input data in each data pair), as shown in FIG. 3B. In some embodiments, the CNN can be structured similar to U-Net architecture, as shown in FIG. 3C. Encoding units included 2D convolutional layers, batch normalization, ReLU activation, and max-pooling. Decoding units included 2D convolutional layers, batch normalization, ReLU activation, and up-sampling, as shown in FIG. 3C. A mean-squared-error loss function was used with respect to the calculated noise map. During training, rotational data augmentation was applied (e.g., by applying rotations to the images and/or image patches in the training data set). In some embodiments, the CNN can be trained twice: once for smooth kernel (B30) and once for medium-sharp kernel (D45). Training can be conducted using a GPU (e.g., an Nvidia GTX 1080 GPU) equipped with TensorFlow and Keras.

FIG. 3D illustrates an example workflow for training and implementing a SILVER model. First, a phantom was scanned with 100 repeated sequential acquisitions as described above. Pixelwise standard deviation was calculated to generate noise maps. Phantom scans (input) and corresponding noise maps (labels) were split into training patches (64×64 pixels). The SILVER neural network model was trained to predict noise map based on CT image. Following training, the SILVER neural network model can be applied to patient CT exams to generate noise maps that quantify pixelwise noise level and/or local noise levels in the input images.

The one or more trained neural networks are then stored for later use, as indicated at step 206. Storing the neural network(s) may include storing network parameters (e.g., weights, biases, or both), which have been computed or otherwise estimated by training the neural network(s) on the training data. Storing the trained neural network(s) may also include storing the particular neural network architecture to be implemented. For instance, data pertaining to the layers in the neural network architecture (e.g., number of layers, type of layers, ordering of layers, connections between layers, hyperparameters for layers) may be stored.

In an example study, the SILVER model described in the present disclosure was evaluated using anthropomorphic phantom images, uniform phantom images, and patient images.

The anthropomorphic phantom test dataset was acquired with 100 repetitions so that a pixel noise map could be calculated as described above. The SILVER model was applied to full phantom CT images (512×512 pixels) and the predicted noise map was compared directly to the calculated noise map. Root-mean-square-error (“RMSE”), difference images, and percent error maps of the predicted noise map relative to the calculated noise map were used to assess performance. Absolute percent error was defined as the difference between the predicted and calculated noise map, divided by calculated noise map, and multiplied by 100%.

For the uniform phantom image data, ROI standard deviation (“SD”) noise measurement repeatability as a function of ROI radius was quantified within a uniform section of a 20 cm diameter cylindrical phantom (ACR CT accreditation phantom, Gammex 464). First, ROI SD measurements of each ROI radius (1 to 20 pixels, 1 pixel increment) were repeated 35 times at 10 degree increments around the uniform cylindrical phantom. For each ROI radius, the percent variability in the 35 repeated ROI SD measurements was calculated. Percent variability was defined as standard deviation in repeat noise measurements, divided by the mean noise level, and multiplied by 100%. SILVER noise measurement repeatability was evaluated for the same uniform cylindrical phantom. For each ROI radius, the mean predicted value from the noise map was recorded 35 times at 10 degree increments around the uniform cylindrical phantom. Percent variability in the mean predicted noise map was calculated. Percent variability within SILVER noise measurements was compared with percent variability of ROI SD measurements as a function of ROI radius.

For the patient image data, the SILVER model was used to predict pixel noise maps in 10 patient CT datasets. This dataset contained patient exams at routine dose (“RD”) and quarter dose (“QD”). The QD patient exams were synthesized using a validated projection-based noise insertion technique that considers the effect of automatic exposure control, bow tie filter, and electronic noise, such as the technique described by L. Yu, et al., in “Development and Validation of a Practical Lower-Dose-Simulation Tool for Optimizing Computed Tomography Scan Protocols,” J Comput Assist Tomogr., 2012; 36(4):477-487. Manual ROI SD measurements were performed at the aorta, liver, spleen, fat, and heart and compared directly with noise levels predicted by SILVER at the same locations. The ROI radius was set to 10 pixels (8 mm), which was the largest ROI radius that could be achieved in the example while still finding uniform regions of each anatomy in the study. Twenty-five uniform regions were pre-selected within each of the ten datasets. ROIs were manually placed by a user. The absolute percent error of each measurement was recorded between SILVER and the ROI SD measurement and average absolute percent error was calculated for each anatomy.

When applied to the anthropomorphic phantom test dataset, the noise map predicted by SILVER closely matched the calculated noise map. The RMSE of the SILVER noise map relative to calculated noise map for the test set of each phantom is included in Table 1.

TABLE 1
Root-mean-squared-error (RMSE, HU) between the SILVER noise map
prediction and the calculated noise map for the test dataset of
three anthropomorphic phantoms (head, chest, and pelvis). RMSE
was calculated for each phantom at routine dose and quarter dose.

| | Smooth Kernel (B30) | | Medium Sharp Kernel (D45) | |
|---|---|---|---|---|
| | Routine | Quarter | Routine | Quarter |
| Phantom | Dose | Dose | Dose | Dose |
| Head | 0.7 | 1.1 | 1.6 | 2.9 |
| Chest | 1.1 | 1.4 | 2.1 | 3.8 |
| Pelvis | 1.5 | 2.5 | 3.5 | 7.5 |
| Average | 1.1 | 1.7 | 2.4 | 4.7 |

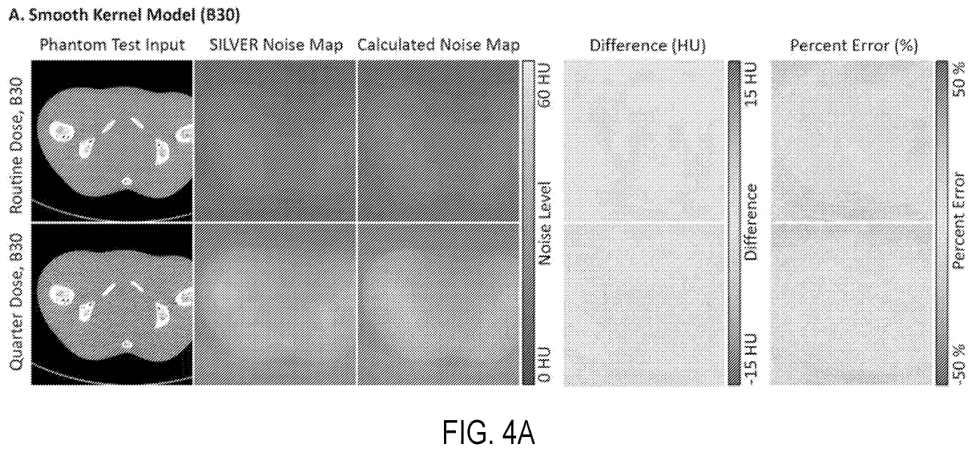

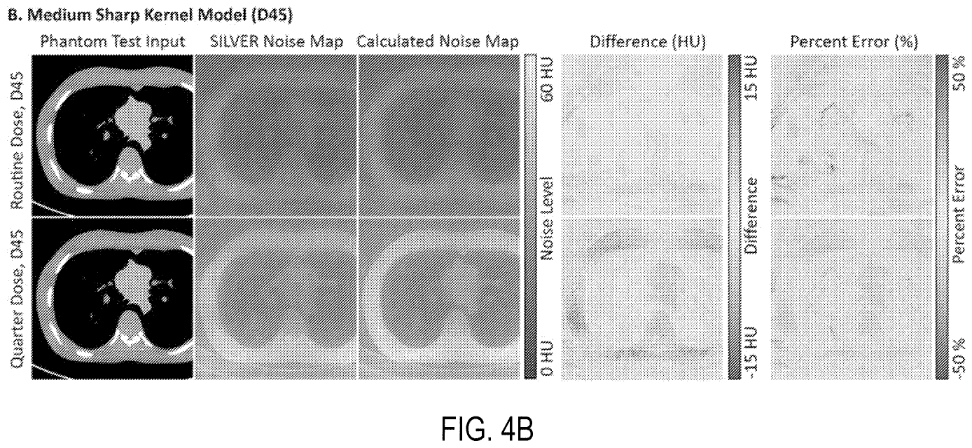

For smooth kernel (B30), the average RMSE of the noise map prediction was 1.1 HU at RD and 1.7 HU at QD. For medium sharp kernel (D45), the average RMSE of the noise map prediction was 2.4 HU for RD and 4.7 HU for QD. In general, the SILVER noise map was most accurate within largely uniform regions and less accurate for detailed structures (i.e., phantom lung structure). Increased error was observed in regions containing streak artifacts (e.g., phantom heart and chest wall). SILVER performed well for both QD and RD exams in terms of RMSE, visual inspection, and percent error calculation, as shown in FIGS. 4A and 4B.

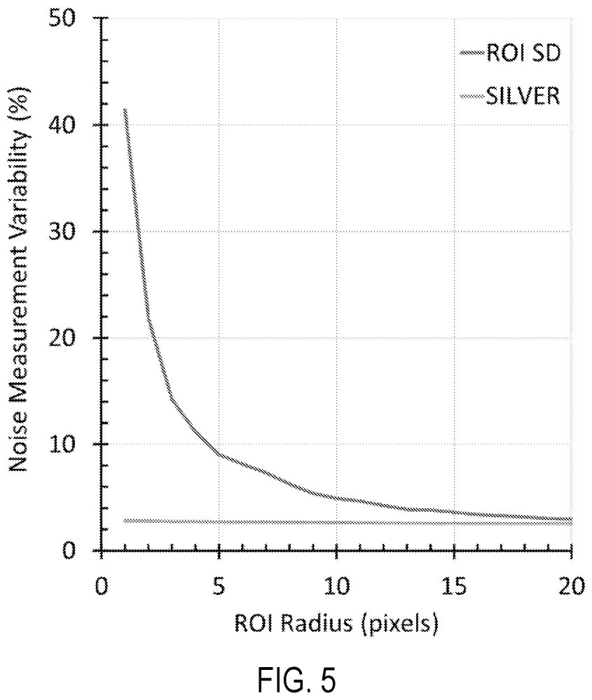

The percent variability within ROI SD measurements exceeded 9% (13 HU/147 HU) for ROI sizes below 5 pixels (4 mm) in radius; to achieve less than 5% (7 HU/147 HU) variability a radius of 10 pixels (8 mm) was used. In contrast, SILVER predicted pixel noise map ROI average had almost no dependency on ROI size. For all conditions studied, variability in SILVER predictions was less than 5%. To provide equivalent repeatability as SILVER, ROI SD measurements required a radius of roughly 20 pixels (16 mm), as shown in FIG. 5.

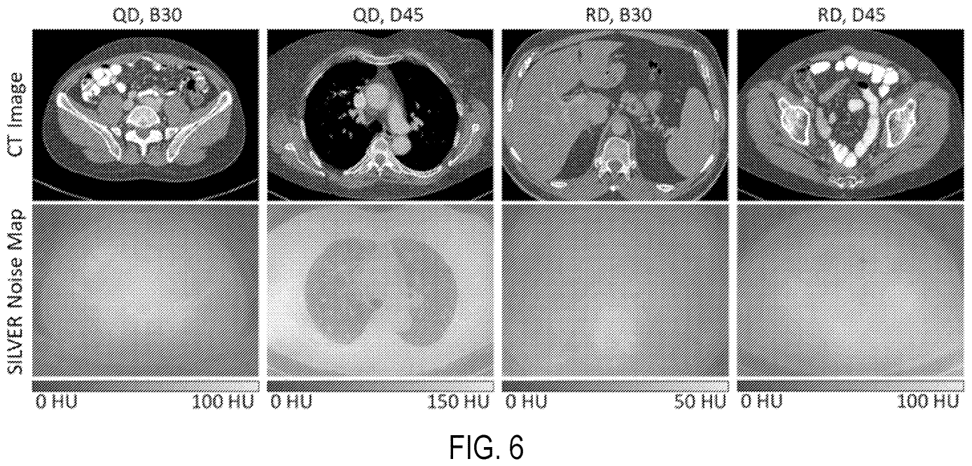

SILVER was used to predict noise maps of ten patient exams for two dose levels (RD and QD) and two reconstruction kernels (B30 and D45). By visual inspection (FIG. 6), SILVER noise prediction matched trends expected regarding patient size (elevated noise observed in large patients), tissue-type (elevated noise in bone relative to soft tissue), and depth of region (elevated noise in center-most regions). The accuracy of SILVER noise map was confirmed by comparing to uniform ROI SD measurements (10-pixel radius) at aorta, liver, spleen, fat, and heart. The absolute percent error of SILVER relative ROI SD measurement is provided for each anatomy in Table 2.

TABLE 2
Average absolute percent error of SILVER versus ROI SD measurement
for preselected regions in patient CT images (heart, aorta,
liver, spleen, fat). Error bars reflect the standard deviation
of percent error in ten patient exams.

| | |
|---|---|
| Quarter Dose: | Routine Dose: |
| Percent Error (%) | Percent Error (%) |

| Region | B30 | D45 | B30 | D45 |
|---|---|---|---|---|
| Heart | 6 ± 4 | 4 ± 2 | 7 ± 7 | 4 ± 4 |
| Aorta | 7 ± 5 | 4 ± 3 | 9 ± 5 | 5 ± 3 |
| Liver | 4 ± 2 | 4 ± 3 | 5 ± 4 | 3 ± 2 |
| Spleen | 4 ± 4 | 3 ± 3 | 7 ± 5 | 4 ± 3 |
| Fat | 6 ± 4 | 4 ± 3 | 7 ± 8 | 4 ± 4 |

Thus, a single-image local variance estimator (SILVER) model for pixelwise noise quantification in CT images has been described. Advantageously, the systems and methods described in the present disclosure use deep learning to quantify noise level directly from CT images. The SILVER model has been validated to achieve high accuracy and superior measurement repeatability relative to ROI SD measurements. Additionally, a widely accessible phantom-based training methodology is used to train the SILVER model. Because this technique operates within the image domain, this framework can be implemented on any CT scanner. Furthermore, because the SILVER model can be trained directly on CT phantom measurements, it can learn the many complexities of CT noise (e.g., Poisson and electronic noise sources, internal data processing, geometric variations, and the reconstruction process).

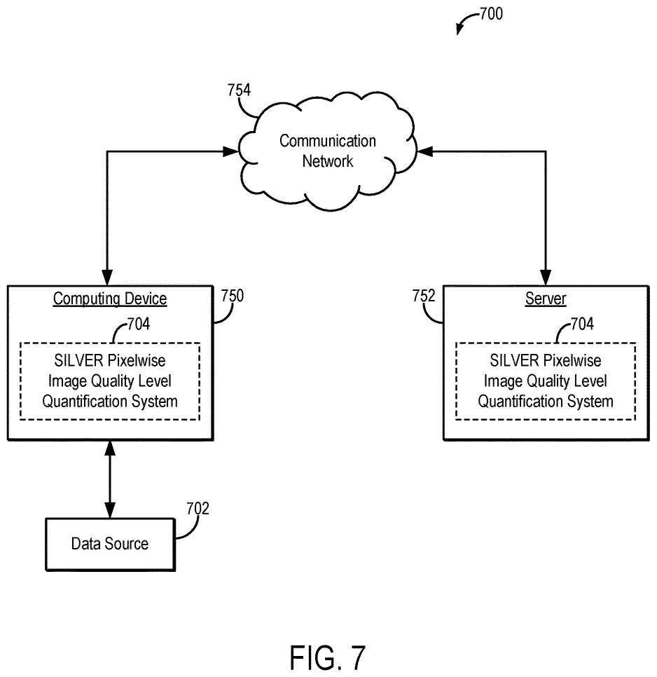

Referring now to FIG. 7, an example of a system 700 for generating patient-specific quantifications of pixelwise noise level, or other image quality level, in CT images in accordance with some embodiments of the systems and methods described in the present disclosure is shown. As shown in FIG. 7, a computing device 750 can receive one or more types of data (e.g., raw projection data, CT images) from data source 702. In some embodiments, computing device 750 can execute at least a portion of a single-scan image local variance estimator (“SILVER”) pixelwise image quality level quantification system 704 to generating image quality metric maps that quantify pixelwise image quality level from data received from the data source 702.

Additionally or alternatively, in some embodiments, the computing device 750 can communicate information about data received from the data source 702 to a server 752 over a communication network 754, which can execute at least a portion of the SILVER pixelwise image quality level quantification system 704. In such embodiments, the server 752 can return information to the computing device 750 (and/or any other suitable computing device) indicative of an output of the SILVER pixelwise image quality level quantification system 704.

In some embodiments, computing device 750 and/or server 752 can be any suitable computing device or combination of devices, such as a desktop computer, a laptop computer, a smartphone, a tablet computer, a wearable computer, a server computer, a virtual machine being executed by a physical computing device, and so on. The computing device 750 and/or server 752 can also reconstruct images from the data.

In some embodiments, data source 702 can be any suitable source of data (e.g., measurement data, images reconstructed from measurement data, processed image data), such as a CT imaging system, another computing device (e.g., a server storing measurement data, images reconstructed from measurement data, processed image data), and so on. In some embodiments, data source 702 can be local to computing device 750. For example, data source 702 can be incorporated with computing device 750 (e.g., computing device 750 can be configured as part of a device for measuring, recording, estimating, acquiring, or otherwise collecting or storing data). As another example, data source 702 can be connected to computing device 750 by a cable, a direct wireless link, and so on. Additionally or alternatively, in some embodiments, data source 702 can be located locally and/or remotely from computing device 750, and can communicate data to computing device 750 (and/or server 752) via a communication network (e.g., communication network 754).

In some embodiments, communication network 754 can be any suitable communication network or combination of communication networks. For example, communication network 754 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 754 can be a local area network, a wide area network, a public network (e.g., the Internet), a private or semi-private network (e.g., a corporate or university intranet), any other suitable type of network, or any suitable combination of networks. Communications links shown in FIG. 7 can each be any suitable communications link or combination of communications links, such as wired links, fiber optic links, Wi-Fi links, Bluetooth links, cellular links, and so on.

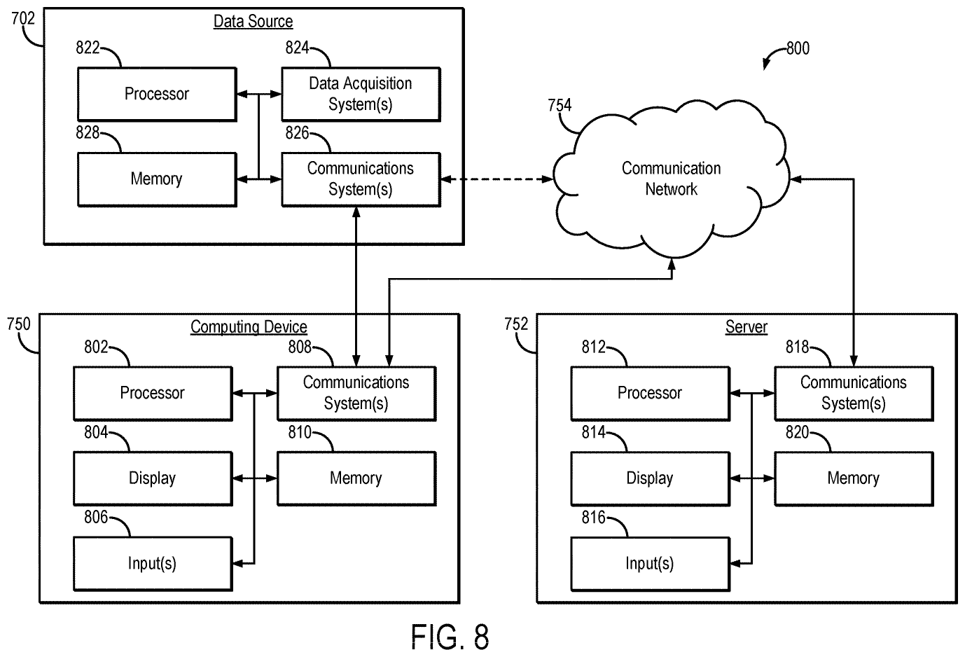

Referring now to FIG. 8, an example of hardware 800 that can be used to implement data source 702, computing device 750, and server 752 in accordance with some embodiments of the systems and methods described in the present disclosure is shown.

As shown in FIG. 8, in some embodiments, computing device 750 can include a processor 802, a display 804, one or more inputs 806, one or more communication systems 808, and/or memory 810. In some embodiments, processor 802 can be any suitable hardware processor or combination of processors, such as a central processing unit (“CPU”), a graphics processing unit (“GPU”), and so on. In some embodiments, display 804 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 806 can include any suitable input devices and/or sensors that can be used to receive user input, such as a keyboard, a mouse, a touchscreen, a microphone, and so on.

In some embodiments, communications systems 808 can include any suitable hardware, firmware, and/or software for communicating information over communication network 754 and/or any other suitable communication networks. For example, communications systems 808 can include one or more transceivers, one or more communication chips and/or chip sets, and so on. In a more particular example, communications systems 808 can include hardware, firmware, and/or software that can be used to establish a Wi-Fi connection, a Bluetooth connection, a cellular connection, an Ethernet connection, and so on.

In some embodiments, memory 810 can include any suitable storage device or devices that can be used to store instructions, values, data, or the like, that can be used, for example, by processor 802 to present content using display 804, to communicate with server 752 via communications system(s) 808, and so on. Memory 810 can include any suitable volatile memory, non-volatile memory, storage, or any suitable combination thereof. For example, memory 810 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 810 can have encoded thereon, or otherwise stored therein, a computer program for controlling operation of computing device 750. In such embodiments, processor 802 can execute at least a portion of the computer program to present content (e.g., images, user interfaces, graphics, tables), receive content from server 752, transmit information to server 752, and so on. For example, the processor 802 and the memory 810 can be configured to perform the methods described herein (e.g., the method of FIG. 1, the method of FIG. 2).

In some embodiments, server 752 can include a processor 812, a display 814, one or more inputs 816, one or more communications systems 818, and/or memory 820. In some embodiments, processor 812 can be any suitable hardware processor or combination of processors, such as a CPU, a GPU, and so on. In some embodiments, display 814 can include any suitable display devices, such as an LCD screen, LED display, OLED display, electrophoretic display, a computer monitor, a touchscreen, a television, and so on. In some embodiments, inputs 816 can include any suitable input devices and/or sensors that can be used to receive user input, such as a keyboard, a mouse, a touchscreen, a microphone, and so on.

In some embodiments, communications systems 818 can include any suitable hardware, firmware, and/or software for communicating information over communication network 754 and/or any other suitable communication networks. For example, communications systems 818 can include one or more transceivers, one or more communication chips and/or chip sets, and so on. In a more particular example, communications systems 818 can include hardware, firmware, and/or software that can be used to establish a Wi-Fi connection, a Bluetooth connection, a cellular connection, an Ethernet connection, and so on.

In some embodiments, memory 820 can include any suitable storage device or devices that can be used to store instructions, values, data, or the like, that can be used, for example, by processor 812 to present content using display 814, to communicate with one or more computing devices 750, and so on. Memory 820 can include any suitable volatile memory, non-volatile memory, storage, or any suitable combination thereof. For example, memory 820 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 820 can have encoded thereon a server program for controlling operation of server 752. In such embodiments, processor 812 can execute at least a portion of the server program to transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone), and so on.

In some embodiments, the server 752 is configured to perform the methods described in the present disclosure. For example, the processor 812 and memory 820 can be configured to perform the methods described herein (e.g., the method of FIG. 1, the method of FIG. 2).

In some embodiments, data source 702 can include a processor 822, one or more data acquisition systems 824, one or more communications systems 826, and/or memory 828. In some embodiments, processor 822 can be any suitable hardware processor or combination of processors, such as a CPU, a GPU, and so on. In some embodiments, the one or more data acquisition systems 824 are generally configured to acquire data, images, or both, and can include a CT imaging system. Additionally or alternatively, in some embodiments, the one or more data acquisition systems 824 can include any suitable hardware, firmware, and/or software for coupling to and/or controlling operations of a CT imaging system. In some embodiments, one or more portions of the data acquisition system(s) 824 can be removable and/or replaceable.

Note that, although not shown, data source 702 can include any suitable inputs and/or outputs. For example, data source 702 can include input devices and/or sensors that can be used to receive user input, such as a keyboard, a mouse, a touchscreen, a microphone, a trackpad, a trackball, and so on. As another example, data source 702 can include any suitable display devices, such as an LCD screen, an LED display, an OLED display, an electrophoretic display, a computer monitor, a touchscreen, a television, etc., one or more speakers, and so on.

In some embodiments, communications systems 826 can include any suitable hardware, firmware, and/or software for communicating information to computing device 750 (and, in some embodiments, over communication network 754 and/or any other suitable communication networks). For example, communications systems 826 can include one or more transceivers, one or more communication chips and/or chip sets, and so on. In a more particular example, communications systems 826 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 828 can include any suitable storage device or devices that can be used to store instructions, values, data, or the like, that can be used, for example, by processor 822 to control the one or more data acquisition systems 824, and/or receive data from the one or more data acquisition systems 824; to generate images from data; present content (e.g., data, images, a user interface) using a display; communicate with one or more computing devices 750; and so on. Memory 828 can include any suitable volatile memory, non-volatile memory, storage, or any suitable combination thereof. For example, memory 828 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 828 can have encoded thereon, or otherwise stored therein, a program for controlling operation of data source 702. In such embodiments, processor 822 can execute at least a portion of the program to generate images, transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for quantifying pixelwise noise level in computed tomography (CT) images of a subject, the method comprising:
(a) accessing with a computer system, a CT image acquired from a subject using a CT imaging system;
(b) accessing with the computer system, a neural network that has been trained on CT images and corresponding noise maps to quantify pixelwise noise levels in input CT image data;
(c) generating a noise map by inputting the CT image to the neural network using the computer system, generating an output as the noise map, wherein the noise map quantifies a pixelwise noise level in the CT image; and
(d) displaying the noise map to a user by the computer system, or storing the noise map using the computer system.

2. The method of claim 1, wherein the neural network is trained on training data using supervised learning and the training data include data pairs comprising a CT image paired with a noise map generated from the CT image.

3-4. (canceled)

5. The method of claim 2, wherein the training data include CT images acquired from a uniform phantom.

6. The method of claim 2, wherein the training data include CT images acquired from a plurality of subjects.

7. The method of claim 2, wherein the noise map in each data pair is computed as a pixelwise standard deviation of the CT image in the data pair.

8. The method of claim 2, wherein the training data are constructed by extracting image patches from each CT image and noise patches from each noise map and forming the data pairs by pairing an image patch with a corresponding noise patch.

9. The method of claim 2, wherein a random linear scaling of image noise is applied to each CT image in the training data.

10. The method of claim 9, wherein the random linear scaling of image noise is applied to each CT image in the training data by:
generating a noise-only difference image by subtracting the CT image by an average of each CT image in the training data;
generating a scaled noise-only difference image by multiplying the noise-only difference image by a random scaling factor; and
generating a random linear scaled CT image by adding the scaled noise-only difference image to the average of each CT image in the training data.

11. (canceled)

12. The method of claim 1, further comprising denoising the CT image with the computer system using the noise map.

13. The method of claim 12, wherein denoising the CT image comprises accessing a denoising neural network that has been trained to denoise CT images and adjusting denoising weights in the denoising neural network using the noise map, and inputting the CT image to the denoising neural network to generate a denoised CT image.

14-17. (canceled)

18. A method for quantifying pixelwise image quality in computed tomography (CT) images of a subject, the method comprising:
(a) accessing with a computer system, a CT image acquired from a subject using a CT imaging system;
(b) accessing with the computer system, a neural network that has been trained on CT images and corresponding image quality metric maps to quantify pixelwise image quality levels in input CT image data;
(c) generating an image quality metric map by inputting the CT image to the neural network using the computer system, generating an output as the image quality metric map, wherein the image quality metric map quantifies a pixelwise image quality level in the CT image, wherein the image quality metric map consists of at least one of a resolution map that quantifies a pixelwise image resolution level in the CT image or a noise correlation map that quantifies a pixelwise noise correlation level in the CT image; and
(d) displaying the image quality metric map to a user by the computer system, or storing the image quality metric map using the computer system.

19. The method of claim 18, wherein the neural network is trained on training data using supervised learning and the training data include data pairs comprising a CT image paired with a noise map generated from the CT image.

20-21. (canceled)

22. The method of claim 19, wherein the training data include CT images acquired from a uniform phantom.

23. The method of claim 19, wherein the training data include CT images acquired from a plurality of subjects.

24. The method of claim 19, wherein the noise map in each data pair is computed as a pixelwise standard deviation of the CT image in the data pair.

25. The method of claim 24, wherein the training data are constructed by extracting image patches from each CT image and noise patches from each noise map and forming the data pairs by pairing an image patch with a corresponding noise patch.

26. The method of claim 19, wherein a random linear scaling of image noise is applied to each CT image in the training data.

27. The method of claim 26, wherein the random linear scaling of image noise is applied to each CT image in the training data by:
generating a noise-only difference image by subtracting the CT image by an average of each CT image in the training data;
generating a scaled noise-only difference image by multiplying the noise-only difference image by a random scaling factor; and
generating a random linear scaled CT image by adding the scaled noise-only difference image to the average of each CT image in the training data.

28. (canceled)

29. A method for training a neural network to quantify pixelwise noise levels in input computed tomography (CT) image data, the method comprising:
accessing training data with a computer system, wherein the training data comprise data pairs comprising a CT image paired with a noise map generated from the CT image;
generating augmented training data with the computer system by applying a random linear scaling of image noise to each CT image in the training data;
training the neural network on the augmented training data using the computer system, generating an output as a pretrained neural network; and
storing the pretrained neural network with the computer system.

30. The method of claim 29, wherein the random linear scaling of image noise is applied to each CT image in the training data by:
generating a noise-only difference image by subtracting the CT image by an average of each CT image in the training data;
generating a scaled noise-only difference image by multiplying the noise-only difference image by a random scaling factor; and
generating a random linear scaled CT image by adding the scaled noise-only difference image to the average of each CT image in the training data.
